(19) United States
(12) Patent Application Publication
(10) Pub. No.: US 2003/0012490 A1
(43) Pub. Date: Jan. 16, 2003

(54) Hybrid WDP/optical cross-connect network architecture

(76) Inventors: William Melaragni, Billerica, MA (US); Bruce A. Schofield, Tyngsboro, MA (US)

Correspondence Address: Samuel J. Petuchowski, Bromberg & Sunstein LLP, 125 Summer Street, Boston, MA, 02110-1618, US

(21) Appl. No.: 09/902,886

(22) Filed: Jul. 11, 2001

(51) Int. Cl. G02B 6/28

(52) U.S. Cl. 385/24

(57) ABSTRACT

A method and apparatus for coupling a plurality of local nodes to a wavelength division multiplexed network. Each local node is connected to an I/O port of an optical cross-connect. Other I/O ports of the optical cross-connect are connected to a wavelength division multiplexer/demultiplexer for coupling the optical cross-connect to a fiber ring network. Additionally, one or more optical-to-tunable-optical converters are connected to ports of the optical cross-connect to transmit data from the local nodes to the WDM mux/demux at a specified wavelength for uplinking onto the fiber ring network.

### FIELD OF THE INVENTION

The present invention relates generally to data transmission networks and, more particularly, to an architecture for networks employing an optical cross-connect hub topology both for local interconnection and connection to a wavelength division multiplexing network.

### BACKGROUND OF THE INVENTION

High speed optical networks, configured, for example, under SONET Synchronous Optical Network) or SDH (Synchronous Digital Hierarchy) standards to employ wavelength division multiplexing (WDM), are typically deployed in a ring configuration. Rings are favored for their topological simplicity as well as their robustness in the presence of such failures as that of transmission equipment.

Pure ring topologies for WDM networks suffer from a number of disadvantages, however. One is the requirement that each node include a high-quality (and costly) laser, of high spectral purity and specified and/or tunable wavelength. Other drawbacks include the complexity and cost of wavelength re-use in order for the ring to emulated a logical mesh, and the requirement that the ring be broken every time a node is added, thereby compromising network availability.

WDM rings typically use traditional Digital Cross Connects (DCCs) in various capacities: as nodes on the ring, to serve as up-links to the ring, and to interconnect multiple rings. Alternatively, a router may be used, in a manner similar to that of a DCC, for interfacing to a ring. Disadvantages of both the DCC and router up-links to the ring lie in their complexity, cost, and limited bandwidth of either solution. Accordingly, a higher bandwidth and lower complexity solution for linking to a ring-configured optical network is desirable.

One solution to the problem of connection to an optical ring is configuration of the network as a fully interconnected mesh rather than a ring. As a fully interconnected mesh, each node of the network is connected to every other node, typically via a non-blocking switch that serves as a hub point for all connections. A ring network topology is favored over that of a mesh, however, because the number of fibers required to support a comparably high bit rate is typically far lower in a ring configuration.

One solution known in the art is that of employing a tranditional DCC as a hub, with some of the DCC's ports dedicated as up-links to a WDM network. Since the DCC is an electronic switch, it's upper bit-rate is limited, typically to a rate below 40 Gbps. While a router may also be used as the central connection point of a network hub, it is slow and complex.

### SUMMARY OF THE INVENTION

In accordance with one aspect of the invention, a hub is provided for interconnecting a plurality of local nodes. The hub has an optical cross-connect with a plurality of I/O ports, with each local node coupled to an I/O port. Additionally, the hub has a wavelength division multiplexer/demultiplexer for coupling the optical cross-connect to a fiber ring network.

In accordance with alternate embodiments of the invention, the optical cross-connect is strictly non-blocking. The hub may also have at least one optical-to-tunable-optical converter coupled to an I/O port of the optical cross-connect.

Each optical-to-to-tunable-optical converter may be an optical-to-electrical-to-tunable-optical converter, and may also have an optical input coupled to a first I/O port of the optical cross-connect and a tunable optical output coupled to a second I/O port of the optical cross-connect.

In accordance with one aspect of the invention, a network of devices is provided that has an optical cross-connect with a plurality of I/O ports. Additionally; the network has a plurality of local nodes, each local node coupled to an I/O port of the optical cross-connect, and a wavelength division multiplexer/demultiplexer for coupling the optical cross-connect to a fiber ring network. The network may also have at least one optical-to-tunable-optical converter coupled to an I/O port of the optical cross-connect.

### BRIEF DESCRIPTION OF THE DRAWINGS

The foregoing description of various embodiments of the invention should be appreciated more fully from the following further description thereof with reference to the accompanying drawings wherein:

FIG. 1 schematically shows a self-contained optical cross-connect switch in accordance with illustrative embodiments of the invention;

FIG. 2 schematically shows optical cross-connect switch for use with non-tunable nodes in accordance with illustrative embodiments of the invention; and

FIG. 3 schematically shows optical cross-connect switch for use with nodes capable of wavelength tuning in accordance with further illustrative embodiments of the invention.

### DESCRIPTION OF PREFERRED EMBODIMENTS OF THE INVENTION

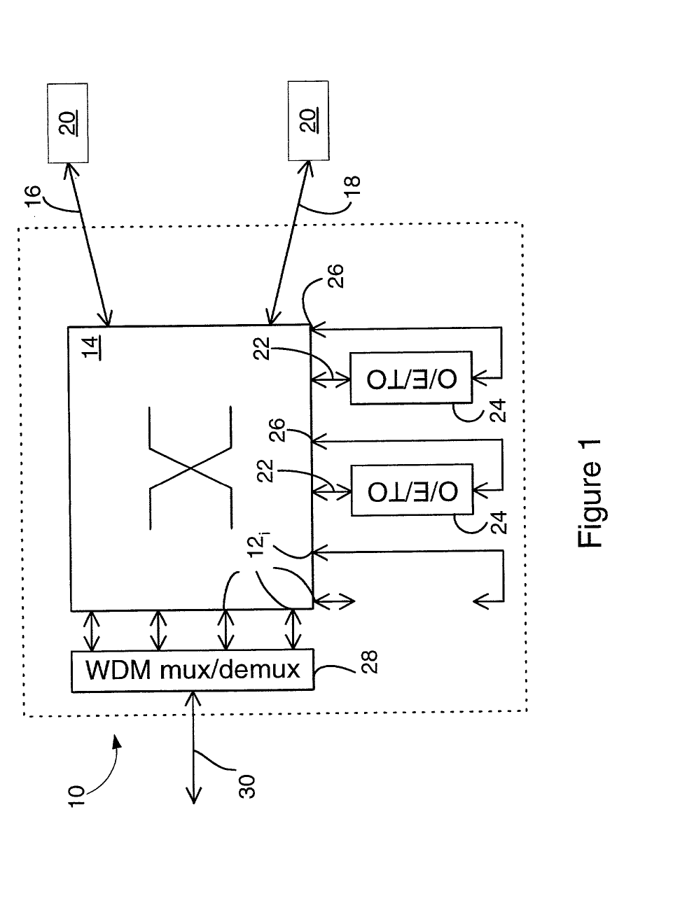

Referring first to FIG. 1, in accordance with preferred embodiments of the present invention, a self-contained cross-connect hub 10, based on photonic cross-connect 14ᵢ is provided for connecting any optical input 12ᵢ to any specified optical output 12ᵢ in a strictly non-blocking sense. It is to be understood that, within the scope of the invention, inputs and outputs 12ᵢ may correspond to identical or separate physical ports, and that the ports may be referred to collectively as I/O ports or I/Os. Physical realization of a photonic cross-connect may be by any means known in the art, as discussed, for example, in Ramaswami and Sivarajan, Optical Networks: A Practical Perspective, (Morgan Kaufman Publishers, 1998), which is hereby incorporated into the present description by reference.

In the embodiment shown in FIG. 1, a subset of optical inputs 16 and outputs 18 are available for connection of local nodes 20. Other cross-connect I/Os 22 are interfaced to a local set of tunable optical-to-tunable-optical converters 24. In preferred embodiments of the invention, the optical-to-tunable-optical converters are optical-to-electrical-to-tunable-optical (O/E/TO) converters. The other sides of the O/E/TO converters 24 are connected back, through cross-connect 10 at ports 26, to WDM multiplexer/demultiplexer (“mux/demux”) devices 28, which are, in turn, connected to one or more optical fibers 30 of a WDM network.

Since the O/E/TO converters 24 provide an optical output of tunable wavelength, the output at port 26 that is switched by cross-connect 10 to interface to the WDM fibers 30 can be dynamically tuned in wavelength to any wavelength used by the system, typically as defined by wavelengths of the ITU C-band grid. Additionally, each node 20 in the local network may, or may not, have tunable output, as appropriate in a particular application, with direct interconnection to the WDM network 30 correspondingly enabled, or not, by cross-connect 10.

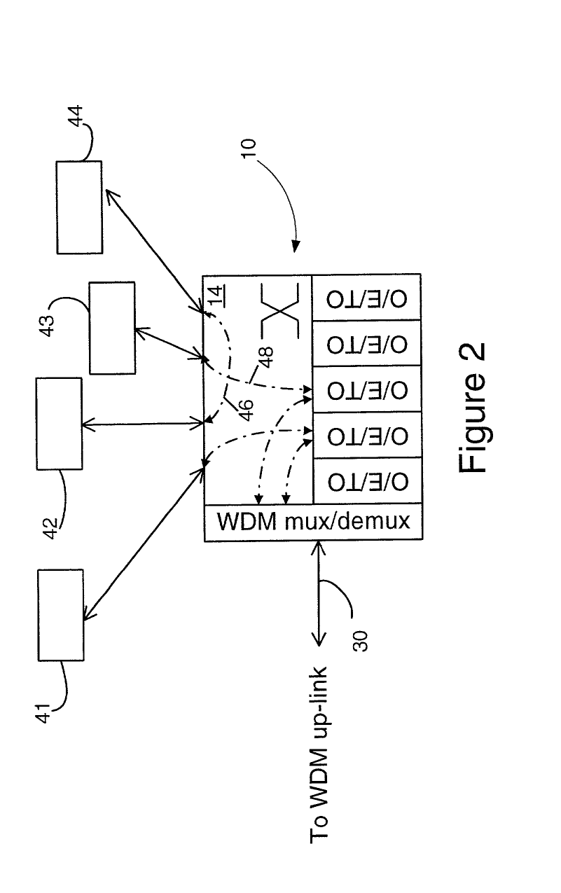

More particularly, FIG. 2 depicts the case of a cross-connect hub 10 interconnecting a plurality of local nodes 41, 42, 43, 44, none of which have tunable wavelength capability. Each node, such as node 42, can be connected, via photonic cross-connect 10, to any other node, such as node 44. The dashed line connection 46 schematically represents a dynamic connection made within photonic cross-connect block 14 between the corresponding nodes 42 and 44. In case a particular node, say node 43, wishes to communicate outside its local area, it may do so via WDM up-ink 30. In this case, cross-connect switch 14 connects node 43 to an available O/E/TO converter 24, with the dynamic link represented by dashed line 48. The O/E/TO converter 24 takes the traffic from node 43 and translates it to the proper wavelength for transmission to the attached WDM network. As thus described, none of the local nodes requires tunable wavelength capability to connect to the WDM network, and the O/E/TO converters 24 O/E/TO converter 24 advantageously provided all necessary tunability, thereby significantly reducing system costs.

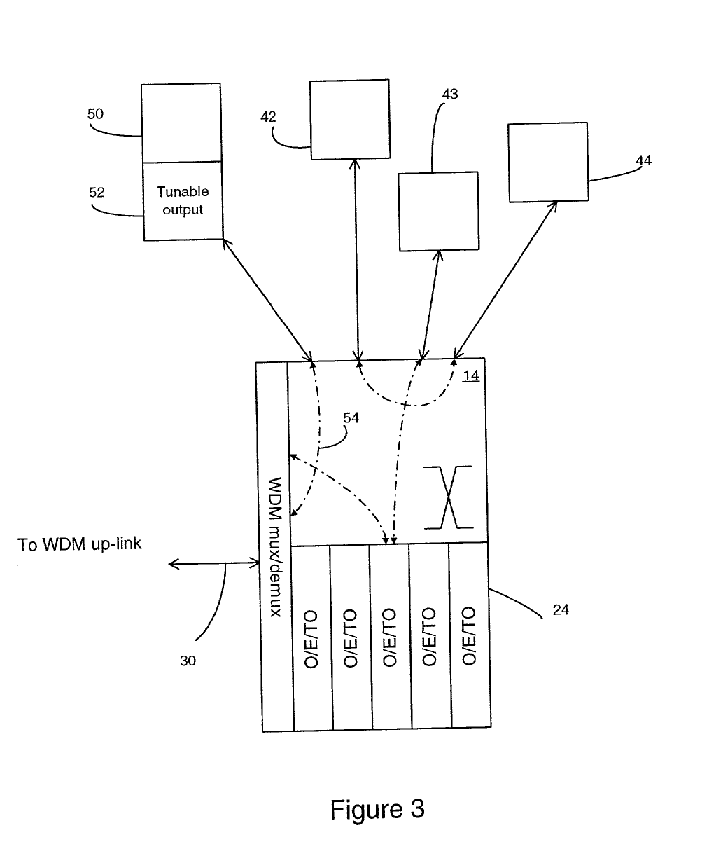

In accordance with further embodiments of the invention now described with reference to FIG. 3, one node 50 or more of the local nodes may be capable of indigenously generating a tunable wavelength output 52. In this case, particularly advantageous if a particular node needs frequent access to the WDM network 30, it can more directly be connected to the up-link, via dynamic link 54 provided by photonic cross-connect block 14, without having to wait for the availability of an O/E/TO converter 24. At the same time, other nodes 41, 42, 43 in the local network may be untunable yet capable of interconnection among each other and with the WDM network, as described above with reference to FIG. 2.

Various of the embodiments of the invention as heretofore described may advantageously provide photonic switching among local peer nodes and between the nodes and a WDM network without the hub constituting the bit-rate limiting element of the network. To first order, at least, the operation of a photonic cross-connect is entirely independent of bit rate, though higher-order dependencies due to filter bandwidth, mode coupling, etc., may be dealt with using practices known in the art.

Some aspects of the invention may be implemented at least in part in any conventional computer programming language comprising computer program code. For example, preferred embodiments may be implemented in a procedural programming language (e.g., “C”) or an object oriented programming language (e.g., “C++”). Alternative embodiments of the invention may be implemented, at least in part, as preprogrammed hardware elements (e.g., application specific integrated circuits, FPGAs, and digital signal processors), analog circuit elements, or other related components.

In other embodiments, the disclosed apparatus and method may be implemented as a computer program product for use with a computer system. Such implementation may include a series of computer instructions fixed either on a tangible medium, such as a computer readable medium (e.g., a diskette, CD-ROM, ROM, or fixed disk) or transmittable to a computer system, via a modem or other interface device, such as a communications adapter connected to a network over a medium. The medium may be either a tangible medium (e.g., optical or analog communications lines) or a medium implemented with wireless techniques (e.g., microwave, infrared or other transmission techniques). The series of computer instructions embodies all or part of the functionality previously described herein with respect to the system. Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies. It is expected that such a computer program product may be distributed as a removable medium with accompanying printed or electronic documentation (e.g., shrink wrapped software), preloaded with a computer system (e.g., on system ROM or fixed disk), or distributed from a server or electronic bulletin board over the network (e.g., the Internet or World Wide Web). Of course, some embodiments of the invention may be implemented as a combination of both software (e.g., a computer program product) and hardware. Still other embodiments of the invention are implemented as entirely hardware, or entirely software (e.g., a computer program product).

Although various exemplary embodiments of the invention have been disclosed, it should be apparent to those skilled in the art that various changes and modifications can be made that will achieve some of the advantages of the invention without departing from the true scope of the invention. These and other obvious modifications are intended to be covered by the appended claims.

What is claimed is:

1. A hub for interconnecting a plurality of local nodes, the hub comprising:
a. an optical cross-connect having a plurality of I/O ports, each local node coupled to an I/O port; and
b. a wavelength division multiplexer/demultiplexer for coupling the optical cross-connect to a fiber ring network.

2. A hub according to claim 1, wherein the optical cross-connect is strictly non-blocking.

3. A hub according to claim 1, further comprising at least one optical-to-tunable-optical converter coupled to an I/O port of the optical cross-connect.

4. A hub according to claim 3, wherein each optical-to-to-tunable-optical converter is an optical-to-electrical-to-tunable-optical converter.

5. A hub according to claim 1, further comprising an optical-to-tunable-optical converter having an optical input coupled to a first I/O port of the optical cross-connect and a tunable optical output coupled to a second I/O port of the optical cross-connect.

6. A network of devices comprising:
a. an optical cross-connect having a plurality of I/O ports;
b. a plurality of local nodes, each local node coupled to an I/O port of the optical cross-connect; and
c. a wavelength division multiplexer/demultiplexer for coupling the optical cross-connect to a fiber ring network.

7. The network as defined by claim 6, further comprising at least one optical-to-tunable-optical converter coupled to an I/O port of the optical cross-connect.

8. A method for coupling a plurality of local nodes to a wave-division-multiplex optical network, the method comprising:
a. coupling each local node to an I/O port of an optical cross-connect;
b. coupling at least one I/O port of the optical cross-connect to a WDM mux/demux device; and
c. coupling the WMD mux/demux device to an optical WDM network.

9. A method according to claim 8, further comprising:
a. switching information from a local node to an optical-to-tunable-optical converter;
b. impressing the information from the local node onto an optical carrier of a specified wavelength; and
c. switching the information to the optical WDM network.

10. A computer program product for use on a computer system for directing data flow among a plurality of local network nodes, the computer program product comprising a computer usable medium having computer readable program code thereon, the computer readable program code comprising:
a. program code for code for impressing modulation upon an optical carrier to represent information for transmission to a specified node;
b. program code for tuning a tunable light source for transmission of information from a local node to a WDM mux/demux for impression upon a WDM network.
